(19) United States
(12) Patent Application Publication
(10) Pub. No.: US 2004/0187633 A1
(43) Pub. Date: Sep. 30, 2004

(54) Extendable coupling structure for use in an engine

(76) Inventor: Siegfried Meyer, Oettingen (DE)

Correspondence Address: ROSENBERG, KLEIN & LEE, 3458 ELLICOTT CENTER DRIVE-SUITE 101, ELLICOTT CITY, MD, 21043, US

(21) Appl. No.: 10/772,459

(22) Filed: Feb. 6, 2004

Related U.S. Application Data
(60) Provisional application No. 60/457,299, filed on Mar. 26, 2003.

(51) Int. Cl. G05G 1/00

(52) U.S. Cl. 74/581

(57) ABSTRACT

An extendable coupling structure used in an engine and coupled between a piston and a crankshaft is constructed to include, a first connector pivoted to the piston, a second connector pivoted to the crankshaft, a hinge coupled between the first connector and the second connector, and a spring-based guide coupled between the bottom end of the first connector and the top end of the second connector and adapted to guide movement of the first connector and the second connector between a close position and an open position and to accelerate rotation of the crankshaft.

### BACKGROUND OF THE INVENTION

1. Field of the Invention

The present invention relates to an internal combustion end and, more specifically, to an extendable coupling structure for use in an engine to connect a crankshaft to a piston and to increase the output torque of the engine.

2. Description of the Related Art

In a typical internal combustion engine, of the type found in most vehicles today, a plurality of pistons are respectively movably mounted in a plurality of cylinders formed in an engine block. Each of the pistons has one end connected with a piston rod and the other end coupled to a crankshaft. When spark plugs in the engine block fired to ignite fuel mixture, the pistons are driven downward to turn the crankshaft, which ultimately drives the entire vehicle. At present, in a typical engine, connecting rods are used and connected with the respective first end to the corresponding piston and the respective second end to the corresponding crankshaft. The connecting points between the two ends of each connecting rod and the corresponding piston and corresponding crankshaft are disposed at the ends of the longitudinal center axis of the respective connecting rod. By means of the coupling of the connecting rod between the corresponding piston and the corresponding crankshaft, reciprocating motion of the piston causes the corresponding crankshaft to rotate.

Presently, researchers have reported many studies to enhance the output torque by extending the moving distance of the connecting rods between the pistons and the crankshafts.

### SUMMARY OF THE INVENTION

The present invention has been accomplished under the circumstances in view. It is one object of the present invention to provide an extendable coupling structure for use in an engine to connect a crankshaft to a piston, which greatly enhances the output torque of the engine.

It is another object of the present invention to provide an extendable coupling structure for use in an engine to connect a crankshaft to a piston, which saves fuel consumption of the engine.

It is still another object of the present invention to provide an extendable coupling structure for use in an engine to connect a crankshaft to a piston, which improves the performance of the engine, resulting in reduced amount of solid matter in exhaust gas of the engine.

To achieve these and other objects and according to one aspect of the present invention, the extendable coupling structure is installed in an engine and coupled between a piston and a crankshaft, comprising a first connector pivoted to the piston, a second connector pivoted to the crankshaft, a hinge coupled between the first connector and the second connector, and a spring-based guide coupled between the bottom end of the first connector and the top end of the second connector and adapted to guide movement of the first connector and the second connector between a close position and an open position and to accelerate rotation of the crankshaft. According to another aspect of the present invention, the spring-based guide comprises a spring guide pin axially movable suspended in a stepped receiving hole in the top end of the second connector, a spring member mounted around the spring guide pin in the stepped receiving hole, the spring member having a top end fixedly fastened to the periphery of the spring guide pin and a bottom end supported on a step inside the stepped receiving hole, and a movable press rod member, the movable press rod member having a top end terminating in a rounded head coupled to a ball socket in the bottom end of the first connector and a bottom end terminating in a flat circular block axially movably fitted into the stepped receiving hole and stopped against the top end of the spring member and the top end of the spring guide pin.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is a sectional plain view of the prior art design.

FIG. 2 is a sectional view showing the detailed structure of an extendable coupling structure according to the present invention.

FIG. 3 is a schematic drawing showing the action of the extendable coupling structure according to the present invention.

FIGS. 4A˜4D are schematic drawings showing one moving cycle of the extendable coupling structure with the piston from the top dead center to the bottom dead center and then from the bottom dead center back to the top dead center according to the present invention.

### DETAILED DESCRIPTION OF THE PREFERRED EMBODIMENT

Reference will now be made in detail to the preferred embodiment of the present invention, examples of which are illustrated in the accompanying drawings. Wherever possible, the same reference numbers are used in the drawings and the description to refer to the same or like parts.

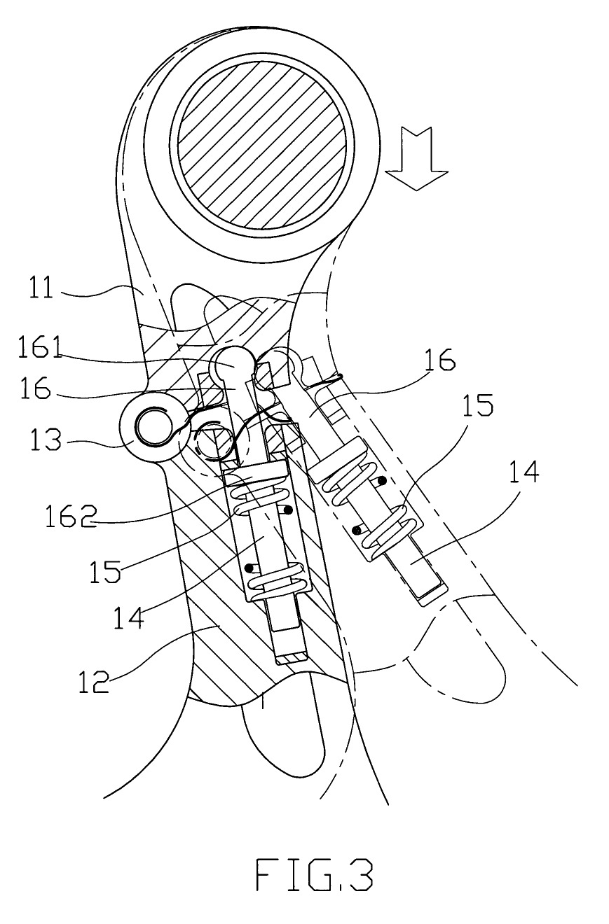

Referring to FIGS. 2 and 3, an extendable coupling structure 1 is shown comprised of a first connector 11, a second connector 12, a hinge 13, a spring member 14, a spring guide pin 15, and a movable press rod member 16.

The first connector 11 has one end, namely, the top end pivoted to a piston A by a pivot pin 110, and the other end, namely, the bottom end terminating in a ball socket 111.

The second connector 12 has one end, namely, the bottom end pivoted to a crankshaft B by a pivot pin 120, and the other end, namely, the top end provided with an axially extended stepped receiving hole 121.

The hinge 13 is connected between the periphery of the bottom end of the first connector 11 and the periphery of the top end of the second connector 12, for enabling the first connector 11 and the second connector 12 to be turned relative to each other.

The spring guide pin 14 is axially movable suspended in the stepped receiving hole 121 in the second connector 12.

The spring member 15 according to this embodiment is a compression spring mounted around the spring guide pin 14 in the stepped receiving hole 121, having a top end fixedly fastened to the periphery of the spring guide pin 14 and a bottom end supported on a step 122 inside the stepped receiving hole 121.

The movable press rod member 16 has a top end terminating in a rounded head 161 coupled to the ball socket 111 of the first connector 11, and a bottom end terminating in a flat circular block 162 axially movably fitted into the stepped receiving hole 121 and stopped against the top end of the spring member 15 and the spring guide pin 14.

Referring to FIG. 3 again, because the first connector 11 and the second connector 12 re connected together by the hinge 13, they can be closed (moved toward each other) and opened (turned outwards from each other). When the first connector 11 and the second connector 12 closed, the movable press rod member 16 is forced downwards to compress the spring member 15, and the spring guide pin 14 is lowered to touch the inside bottom end of the stepped receiving hole 121. On the contrary, when the first connector 11 gives no pressure to the movable press rod member 16, the spring member 15 immediately returns to its former shape, imparting an upward pressure to the spring guide pin 14 and the movable press rod member 16. Further, because the movable press rod member 16 is coupled between the ball socket 111 of the first connector 11 and the stepped receiving hole 121 of the second connector 12, it limits the turning angle between the first connector 11 and the second connector 12 to a limited range.

As an alternate form of the present invention, the spring guide pin 14 may be formed integral with the flat circular block 162 of the movable press rod member 16.

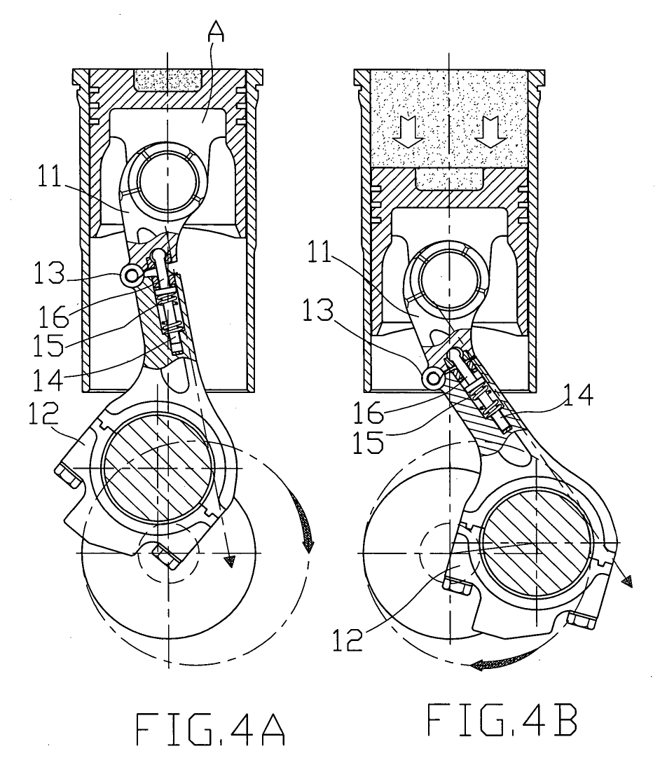

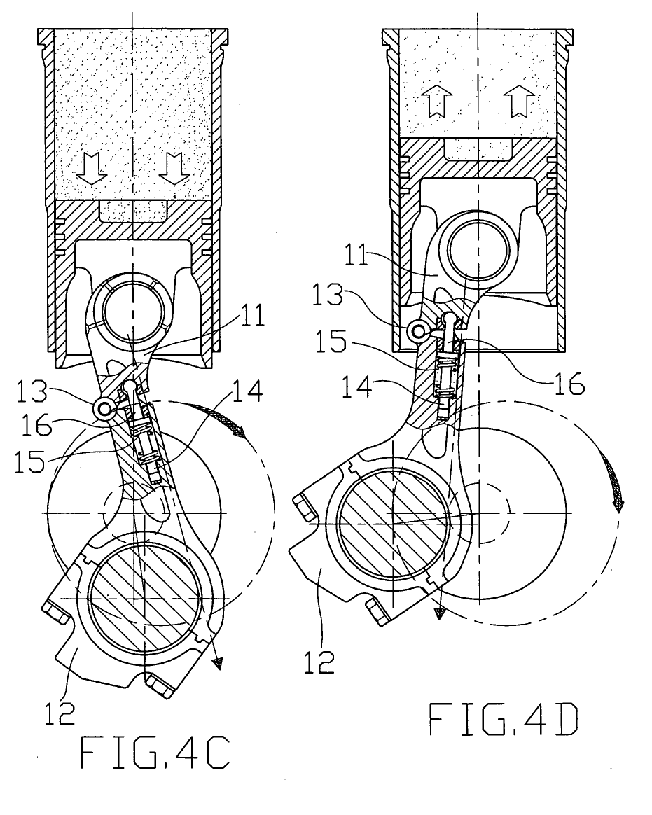

Referring to FIGS. 4A˜4D, when the extendable coupling structure 1 moved with the piston A to the top dead center in the combustion engine, the spring member 15 is released. When the piston A moving downwards from the top dead center in the combustion engine toward the bottom dead center, the spring member 15 is compressed by the movable press rod member 16, and the spring guide pin 14 is lowered to touch the inside bottom end of the stepped receiving hole 121, imparting a pressure to force the crankshaft B to rotate, and therefore the piston A is moved with the extendable coupling structure 1 rapidly downwardly to the bottom dead center in the combustion engine. When the piston A was moved with the extendable coupling structure 1 to the bottom dead center in the combustion engine, the spring member 14 is released. When the spring member 15 returned to its former shape during reciprocating motion of the piston A, it imparts a pressure to the second connector 12 against the crankshaft B, accelerating the rotation of the crankshaft B. Therefore, the spring member 15 is alternatively compressed and released during reciprocating motion of the piston A, and the reciprocating speed of the piston A is accelerated.

As indicated above, the extendable coupling structure of the present invention uses a spring member to accelerating the rotary motion of the crankshaft during reciprocating motion of the piston, thereby enhancing the output torque of the engine. Because the invention greatly improves the performance of the engine, the engine can save much fuel and reduces the production of waste gas.

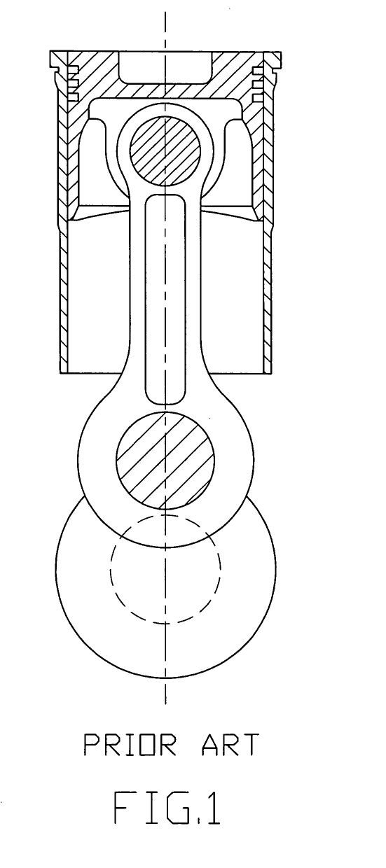

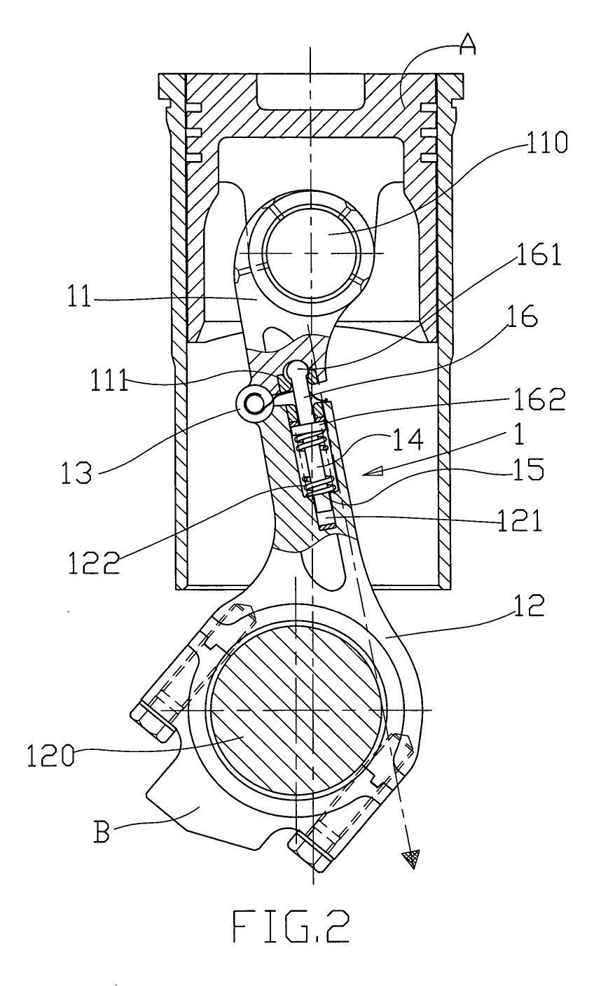

A prototype of extendable coupling structure for use in an engine has been constructed with the features of FIGS. 1˜4. The extendable coupling structure for use in an engine functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An extendable coupling structure used in an engine and coupled between a piston and a crankshaft, comprising:
a first connector, said first connector having a top end pivoted to said piston and a bottom end;
a second connector, said second connector having a bottom end pivoted to said crankshaft and a top end;
hinge means coupled between the periphery of the bottom end of said first connector and the periphery of the top end of said second connector for enabling said first connector and said second connector to be turned relative to each other between a close position and an open position; and
spring-based guide means coupled between the bottom end of said first connector and the top end of said second connector and adapted to guide movement of said first connector and said second connector between said close position and said open position.

2. The extendable coupling structure as claimed in claim 1, wherein said first connector comprises a ball socket formed in the bottom end thereof, said second connector comprises a stepped receiving hole axially extended in the top end thereof; said spring-based guide means has first end coupled to the ball socket of said first connector and a second end axially movably coupled to the stepped receiving hole of said second connector.

3. The extendable coupling structure as claimed in claim 2, wherein said spring-based guide means comprises a spring guide pin axially movable suspended in said stepped receiving hole of second connector, said spring guide pin having a top end aimed at said ball socket of said second connector, a spring member mounted around said spring guide pin in said stepped receiving hole, said spring member having a top end fixedly fastened to the periphery of said spring guide pin and a bottom end supported on a step inside said stepped receiving hole, and a movable press rod member, said movable press rod member having a top end terminating in a rounded head coupled to said ball socket of said first connector and a bottom end terminating in a flat circular block axially movably fitted into said stepped receiving hole and stopped against the top end of said spring member and the top end of said spring guide pin.

4. The extendable coupling structure as claimed in claim 3, wherein said spring member is a compression spring.

5. The extendable coupling structure as claimed in claim 3, wherein said spring guide pin has the top end thereof formed integral with the flat circular block of said movable press rod member.
